(19) United States
(12) Patent Application Publication
(10) Pub. No.: US 2013/0033691 A1
(43) Pub. Date: Feb. 7, 2013

(54) Method and Apparatus for Loading a Substrate

(71) Applicant: Abraham Alexander Soethoudt, Utrecht (NL)

(72) Inventor: Abraham Alexander Soethoudt, Utrecht (NL)

(73) Assignee: ASML Netherlands B.V., Veldhoven (NL)

(21) Appl. No.: 13/641,212

(22) PCT Filed: Feb. 21, 2011
(86) PCT No.: PCT/EP2011/052541

§ 371 Date: Oct. 15, 2012

Related U.S. Application Data
(60) Provisional application No. 61/327,160, filed on Apr. 23, 2010.

(51) Int. Cl. G03B 27/58

(52) U.S. Cl. 355/72; 355/77

(57) ABSTRACT

A method and apparatus for loading a substrate (W) onto a substrate table (WT) then moving the substrate table such that, in the reference frame of the substrate, the substrate table accelerates downwards with an acceleration which is at least 10% of the acceleration due to gravity, thereby reducing friction between the substrate and the substrate table such that deformations of the substrate may at least partially dissipate from the substrate.

### CROSS-REFERENCE TO RELATED APPLICATIONS

This application claims the benefit of U.S. provisional application 61/327,160 which was filed on Apr. 23, 2010, and which is incorporated herein in its entirety by reference.

### BACKGROUND OF THE INVENTION

1. Field of the Invention

The present invention relates to a method and apparatus which may be used in connection with lithography.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

When forming an IC (or other device) it is necessary to provide several layers of patterns on the substrate, the patterns combining to form functional elements of the IC. The patterns must be aligned accurately with one another, in order to ensure that they combine together correctly and thereby form the functional elements. If the patterns are not aligned sufficiently accurately, then the functional elements will not be formed correctly and will not operate. The accuracy with which successive patterns are aligned relative to one another by a lithographic apparatus is commonly referred to as the overlay of the lithographic apparatus.

In order to achieve a desired overlay when projecting a pattern onto a substrate, the positions of target portions on the substrate are measured prior to projection of the pattern. This process is commonly referred to as alignment. In some instances, the position of each target portion is measured separately using alignment marks associated with each target portion. This is sometimes referred to as local alignment. In other instances, the positions of several alignment marks spread around the substrate are measured, and the positions of the target portions are calculated based on these measurements. This is sometimes referred to as global alignment.

The accuracy with which alignment is achieved may be reduced if the substrate has been deformed, thus causing a deterioration of the overlay of the lithographic apparatus. This deterioration of the overlay due to deformation of the substrate may be particularly pronounced when global alignment is used.

It is desirable to provide an apparatus and method which reduces deformation of the substrate.

According to a first aspect of the invention, there is provided a method comprising loading a substrate onto a substrate table then moving the substrate table such that, in the reference frame of the substrate, the substrate table accelerates downwards with an acceleration which is at least 10% of the acceleration due to gravity, thereby reducing friction between the substrate and the substrate table such that deformations of the substrate may at least partially dissipate from the substrate.

According to a second aspect of the invention there is provided an apparatus comprising a substrate table and a positioner, the positioner being configured to move the substrate table such that, in the reference frame of the substrate, the substrate table accelerates downwards with an acceleration which is at least 10% of the acceleration due to gravity, thereby reducing friction between the substrate and the substrate table such that deformations of the substrate may at least partially dissipate from the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed schematic depiction of the lithographic apparatus, including an LPP source collector module SO; and

FIG. 3 is an enlarged schematic depiction of a substrate table and positioner of the lithographic apparatus, together with a substrate.

### DETAILED DESCRIPTION OF THE INVENTION

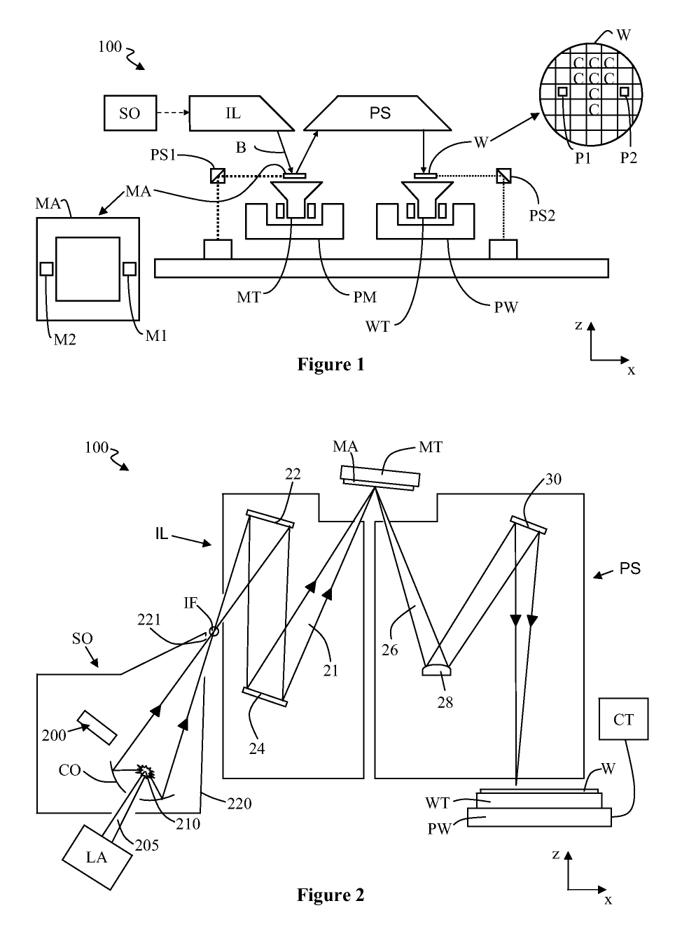

FIG. 1 schematically depicts a lithographic apparatus 100 according to one embodiment of the invention. The apparatus comprises:
an illumination system (illuminator) IL configured to condition a radiation beam B (e.g., EUV radiation).
a support structure (e.g., a mask table) MT constructed to support a patterning device (e.g., a mask or a reticle) MA and connected to a first positioner PM configured to accurately position the patterning device;
a substrate table (e.g., a wafer table) WT constructed to hold a substrate (e.g., a resist-coated wafer) W and connected to a second positioner PW configured to accurately position the substrate; and
a projection system (e.g., a reflective projection system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g., employing a reflective mask). However, in an alternative embodiment, the apparatus may be of a transmissive type (e.g., including a transmissive mask and transmissive optics).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet (EUV) radiation beam from the source collector module SO. Methods to produce EUV radiation include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as facetted field and pupil minor devices. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW (referred to hereafter as the substrate table positioner) and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

The depicted apparatus could be used in at least one of the following modes:

1. In step mode, the support structure (e.g., mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.

2. In scan mode, the support structure (e.g., mask table) MT and the substrate table WT are scanned synchronously while a pattern imparted to the radiation beam is projected onto a target portion C (i.e. a single dynamic exposure). The velocity and direction of the substrate table WT relative to the support structure (e.g., mask table) MT may be determined by the (de-)magnification and image reversal characteristics of the projection system PS.

3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2 shows the lithographic apparatus 100 in more detail, including the source collector module SO, the illumination system IL, and the projection system PS. The source collector module SO is constructed and arranged such that a vacuum environment can be maintained in an enclosing structure 220 of the source collector module SO.

A laser LA is arranged to deposit laser energy via a laser beam 205 into a fuel, such as xenon (Xe), tin (Sn) or lithium (Li) which is provided from a fuel supply 200, thereby creating a highly ionized plasma 210 with electron temperatures of several 10's of eV. The energetic radiation generated during de-excitation and recombination of these ions is emitted from the plasma, collected and focussed by a near normal incidence collector optic CO.

Radiation that is reflected by the collector optic CO is focused in a virtual source point IF. The virtual source point IF is commonly referred to as the intermediate focus, and the source collector module SO is arranged such that the intermediate focus IF is located at or near an opening 221 in the enclosing structure 220. The virtual source point IF is an image of the radiation emitting plasma 210.

Subsequently, the radiation traverses the illumination system IL, which may include a facetted field mirror device 22 and a facetted pupil minor device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the or substrate table WT.

More elements than shown may generally be present in the illumination system IL and projection system PS. Further, there may be more minors present than those shown in the Figures, for example there may be 1-6 additional reflective elements present in the projection system PS than shown in FIG. 2.

In use, a pattern provided on the patterning device MA is projected by the projection system PS onto target portions C of the substrate W. Once the substrate W has been patterned, the substrate table positioner PW moves the substrate table WT to a substrate loader (not shown) of the lithographic apparatus, which removes the substrate W from the substrate table and replaces it with another substrate. The substrate table positioner PW then returns the substrate table WT to its position beneath the projection system PS. The pattern on the patterning device MA is then projected onto target regions C of the substrate W by the projection system PS.

In some instances, a substrate may become deformed when it is loaded onto the substrate table WT. This deformation of the substrate W may for example arise as a consequence of the manner in which the substrate is loaded onto the substrate table WT by the substrate loader. For example, if the substrate W is loaded onto the substrate table WT in a vacuum, then natural lubrication between the substrate and the substrate table which would normally arise from the presence of air, does not occur. For this reason, deformation of the substrate may be more pronounced in an EUV lithography apparatus than a DUV lithography apparatus. Deformation of the substrate W is undesirable, since this may reduce the accuracy with which a pattern is projected by the lithographic apparatus onto the substrate. For example, deformation of the substrate may be detrimental to the overlay of the lithographic apparatus (i.e. the accuracy with which a pattern projected onto the substrate is aligned with a pattern already provided on a substrate). Deterioration of the overlay due to deformation of the substrate may be particularly pronounced when global alignment is used (i.e. when alignment comprises measuring the positions of several alignment marks spread around the substrate and calculating the positions of the target portions based on these measurements).

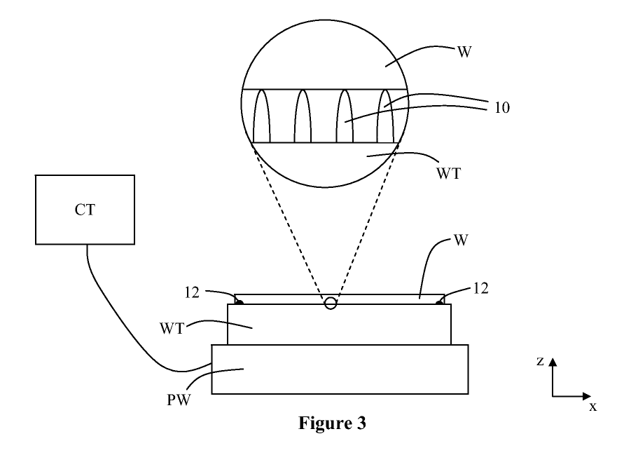

FIG. 3 shows the substrate W, substrate table WT and substrate table positioner PW, including an enlarged view of part of the substrate holder and the substrate. As can be seen from the enlarged view, the substrate W rests on protrusions 10, which extend from the surface of the substrate table WT. The protrusions 10 are commonly referred to as burls. The burls 10 may for example have a height of between 10 μm and 1 mm. The burls 10 support the substrate W whilst at the same time allowing debris particles on the bottom surface of the substrate to fall from the substrate and rest between the burls.

As mentioned further above, deformation of the substrate W which arises when the substrate is loaded onto the substrate table WT may reduce the accuracy with which a pattern is projected onto the substrate. Friction arises between the burls 10 and the bottom surface of the substrate W, and this friction inhibits the substrate from moving relative to the burls. If the substrate were to be able to move freely relative to the burls, then deformations which arise in the substrate when the substrate is loaded onto the substrate table WT would dissipate via equalisation of stresses within the substrate. However, the friction between the substrate W and the burls 10 prevents this from occurring, and the deformations of the substrate thus remain.

In an embodiment, the substrate table WT undergoes a downward acceleration, which creates a period of free-fall for the substrate W. In a reference frame of the substrate table WT, when this is done the substrate W no longer has any weight. The substrate table WT thus exerts no reaction force on the substrate W. In a simplified example, it may be assumed that no Van der Waals forces exist between the substrate and the substrate table. Friction between the burls 10 and the substrate W arises from the weight of the substrate and the associated reaction force exerted by the substrate table WT. Thus, friction no longer arises when the weight of the substrate W in the reference frame of the substrate table WT has been reduced to zero. Since no friction arises between the substrate W and the substrate table WT, the substrate is able to move relative to the burls and deformations of the substrate may dissipate via equalisation of stresses within the substrate.

The downward acceleration of the substrate table WT may be equal to or greater than the acceleration due to gravity. The downward acceleration of the substrate table WT may for example be two times the acceleration due to gravity or greater.

The substrate table positioner PW may include a motor, which is configured to move the positioner with a desired downward acceleration. In other words, the substrate table is accelerated away from the substrate, such as in a direction generally perpendicular to a face surface (i.e., the bottom surface) of the substrate W.

In an embodiment, the substrate table WT undergoes a downward acceleration which does not create a period of free-fall for the substrate W, but which reduces the friction arising between the substrate and the substrate table. For example, the downward acceleration of the substrate table WT may be 50% of the acceleration due to gravity. In the reference frame of the substrate table WT, when this is done the substrate W has 50% of its normal weight. The substrate table WT thus exerts 50% of the normal reaction force on the substrate W. The friction between the burls 10 and the substrate W is therefore reduced. Since the friction between the substrate W and the substrate table WT is reduced, the substrate is more able to move relative to the burls, thereby allowing deformations of the substrate to dissipate more (compared with the case if the substrate table were not moving).

The downward acceleration of the substrate table WT may for example be 10% or more of the acceleration due to gravity, may for example be 50% or more of the acceleration due to gravity, may for example be 70% or more of the acceleration due to gravity, and may for example be 90% or more of the acceleration due to gravity. In general, a greater downward acceleration of the substrate will allow deformations to dissipate more fully from the substrate. However, it may be the case that a relatively small downward acceleration, for example 10% of the acceleration due to gravity, will give rise to a useful dissipation of deformations from the substrate.

Van der Waals forces may act between the substrate W and the burls 10, inhibiting relaxation of the substrate W even when the substrate no longer has any weight and the substrate table WT exerts no reaction force on the substrate W. This is because the Van der Waals forces give rise to friction between the substrate and the burls. The Van der Waals forces may be temporarily removed by providing a downward acceleration of the substrate table WT which is sufficient to introduce a gap between the substrate W and the burls 10. Introducing the gap will reduce or eliminate the Van der Waals forces, thereby allowing the substrate to move relative to the burls. The downward acceleration may for example be greater than the acceleration due to gravity, may for example be greater than twice the acceleration due to gravity, and may for example be greater than three times the acceleration due to gravity. The downward acceleration may for example be up to 10 times the acceleration due to gravity.

In an embodiment, the downward acceleration may begin from a stationary position.

The downward acceleration of the substrate table WT may take place for a period of time which is sufficient to allow at least some dissipation of deformations from the substrate. This time arises from material properties of the substrate, and in the case of a silicon wafer may for example be in the range of 1-10 ms. In an embodiment, the downward acceleration may be equal to the acceleration due to gravity, and the substrate table, and may begin from a stationary position. Where this is the case, the distance travelled by the substrate table may for example be in the range of 50-500 μm.

The downward acceleration of the substrate table WT may for example be incorporated into an up and down movement of the substrate table (e.g., from a starting position to an uppermost position, and then downwards to a stopping position). In this context, downward acceleration of the substrate table WT may occur in the reference frame of the substrate W, even though the substrate table WT is moving upwards (in the reference frame of the lithographic apparatus).

The downward acceleration of the substrate table WT may be repeated a plurality of times. This may allow deformations of the substrate to dissipate more (compared with the case if the downward movement of the substrate table WT was performed only once). The downward acceleration may form part of a cyclical movement of the substrate table WT (e.g., from a starting position to a lowermost position, and then back to the starting position). The cyclical movement may for example be a vibration. The vibration may begin with a small amplitude, grow in amplitude, then reduce in amplitude until the movement ceases. The vibration may for example be applied by a motor which forms part of the substrate table positioner PW. When a vibration is applied to the substrate table WT, downward acceleration of the substrate table WT may occur in the reference frame of the substrate W, even though the substrate table WT is moving upwards (in the reference frame of the lithographic apparatus).

When a vibration is applied to the substrate table WT, the distance moved by the substrate table will depend upon the frequency of the vibration. For example, if an acceleration equal to the acceleration due to gravity (referred to here as 1 g) is applied with a vibration of 50 Hz, then the distance moved by the substrate table will be around 300 μm. If an acceleration of 1 g is applied with a vibration of 100 Hz then the distance moved by the substrate table is only around 80 μm. The vibration may be applied with any suitable frequency. The frequency may for example be equal to or greater than 50 Hz, and may for example be equal to or greater than 100 Hz.

Embodiments of the invention may be said to have in common that in the reference frame of the substrate, the substrate table accelerates downwards (away from the substrate).

The substrate table positioner PW may be configured to move the substrate table WT in the manner described above. The substrate table positioner PW may be controlled by a controller CT which is connected to the substrate table positioner PW. The controller may be configured to send control signals to the substrate table positioner PW which cause the substrate table positioner to move as described above.

Once deformations of the substrate have dissipated, the substrate may then be clamped to the substrate table WT. A seal 12 is located on the substrate table WT and comes into contact with the substrate W when the substrate W is loaded onto the substrate table. The seal is located adjacent to an outer perimeter of the substrate W. A pump (not shown) may be used to pump gas from space between the substrate W and a substrate table WT, thereby establishing a vacuum between the substrate W and the substrate table. The seal 12 prevents gas from flowing into the space between the substrate and the substrate table and thereby breaking the vacuum. The vacuum established between the substrate W and the substrate table WT draws the substrate W towards the substrate table WT, thereby clamping the substrate to the substrate table.

In an alternative embodiment (not shown) electrostatic attraction is used to clamp the substrate W to the substrate table WT instead of using a vacuum.

In an embodiment, part of the substrate W may be clamped to the substrate table WT during the downward acceleration of the substrate table. This may be done for example if lateral movement of the substrate on the substrate table or rotation of the substrate on the substrate table occurs during downward acceleration of the substrate table WT. Locally clamping part of the substrate to the substrate table may eliminate or reduce such movement. Local clamping of part of the substrate W to the substrate table WT in this manner may for example be achieved using a locally applied electrostatic attraction, a locally applied vacuum, or any other suitable local clamping apparatus. In an embodiment, the substrate W may be locally clamped to the substrate table WT at two locations during downward acceleration of the substrate table. The substrate W may then be locally clamped to the substrate table WT at two different locations during subsequent downward acceleration of the substrate table. The locations at which the substrate W is locally clamped may be alternated in this manner for several downward accelerations of the substrate table WT, each alternation allowing deformations of the substrate to dissipate at unclamped locations.

In an embodiment, instead of locally clamping part of the substrate W to the substrate table WT using electrostatic clamping or a vacuum, part of the substrate may be secured to the substrate table by moving part of the substrate table downward with a slower acceleration. For example, one side of the substrate table WT may be moved downwards with an acceleration which is 90% of the acceleration due to gravity (referred to here as 0.9 g), and the remainder of the substrate table may be moved downwards with an acceleration which is 110% of the acceleration due to gravity (referred to here as 1.1 g). This will cause the substrate table WT to tilt as it is moving downwards. The part of the substrate W which is moving downwards with an acceleration of 0.9 g will be held on the substrate table WT more securely than the remainder of the substrate, and may thus provide some resistance to lateral movement or rotation of the substrate.

In above described embodiments of the invention, the term “reference frame of the substrate” may be understood to have a meaning which is conventional in physics. In the context of the invention, this may be interpreted as meaning that movement of the substrate table is defined relative to any movement of the substrate. As an illustrative example, if the substrate is moving upwards and the substrate table is moving upwards at the same velocity, the substrate table is stationary in the reference frame of the substrate. In a further example, if the substrate is moving upwards at a velocity Vₛ and the substrate table is moving upwards at a slower velocity V_{ST}, then the substrate table is moving downwards in the reference frame of the substrate.

Although embodiments of the invention have been described in relation to a lithographic apparatus which is configured to use EUV radiation, the invention may for example be used in a lithographic apparatus which is configured to use DUV radiation.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

Although embodiments of the invention have been described in the context of a lithographic apparatus, the invention may be used in other contexts.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus it will be apparent to one skilled in the art that modifications may be made to the invention as described without departing from the scope of the claims set out below.

1. A method comprising:
loading a substrate onto a substrate table of a lithographic apparatus;
then moving the substrate table such that the substrate table accelerates downwards with an acceleration which is at least 10% of the acceleration due to gravity, thereby reducing friction between the substrate and the substrate table such that deformations of the substrate may at least partially dissipate from the substrate,
wherein part of the substrate is locally clamped to the substrate table during the downward acceleration of the substrate table.

2. The method of claim 1, wherein the acceleration is at least 50% of the acceleration due to gravity.

3. The method of claim 2, wherein the acceleration is equal to or greater than the acceleration due to gravity.

4. The method of claim 3, wherein the acceleration is two times the acceleration due to gravity or greater.

5. The method of claim 2, wherein the substrate is not clamped to the substrate table during the downward movement of the substrate table.

6.-7. (canceled)

8. The method of claim 1, wherein the method further comprises subsequently clamping the substrate to the substrate table.

9. The method of claim 1, wherein the method is performed in a lithographic apparatus.

10. The method of claim 9, wherein the method further comprises projecting a pattern onto the substrate using a projection system of the lithographic apparatus.

11. A lithographic apparatus comprising:
a substrate table configured to support a substrate; and
a positioner configured to move the substrate table such that the substrate table accelerates downwards with an acceleration which is at least 10% of the acceleration due to gravity, thereby reducing friction between the substrate and the substrate table such that deformations of the substrate may at least partially dissipate from the substrate,
wherein the substrate table further comprises a local clamping apparatus configured to clamp part of the substrate to the substrate table during the downward acceleration of the substrate table.

12. The apparatus of claim 11, wherein the positioner is configured to move the substrate table downwards with an acceleration which is at least 50% of the acceleration due to gravity.

13. The apparatus of claim 12, wherein the positioner is configured to move the substrate table downwards with an acceleration which is equal to or greater than the acceleration due to gravity.

14. The apparatus of claim 13, wherein the positioner is configured to move the substrate table downwards with an acceleration which is two times the acceleration due to gravity or greater.

15. (canceled)

16. The apparatus of claim 11, wherein the lithographic apparatus further comprises:
an illumination system configured to condition a radiation beam;
a support constructed to support a patterning device, the patterning device being capable of imparting the radiation beam with a pattern in its cross-section to form a patterned radiation beam;
and
a projection system configured to project the patterned radiation beam onto a target portion of the substrate.

17. A method comprising:
loading a substrate onto a substrate table of a lithographic apparatus; then
moving the substrate table such that the substrate table accelerates downwards with an acceleration which is at least 10% of the acceleration due to gravity, thereby reducing friction between the substrate and the substrate table such that deformations of the substrate may at least partially dissipate from the substrate,
wherein part of the substrate is secured to the substrate table during the downward acceleration of the substrate table by accelerating part of the substrate table downward with a slower acceleration.

18. A lithographic apparatus comprising:
a substrate table configured to support a substrate; and
a positioner configured to move the substrate table such that the substrate table accelerates downwards with an acceleration which is at least 10% of the acceleration due to gravity, thereby reducing friction between the substrate and the substrate table such that deformations of the substrate may at least partially dissipate from the substrate,
wherein the positioner is configured to secure part of the substrate to the substrate table during the downward acceleration of the substrate table by accelerating part of the substrate table downward with a slower acceleration.
